(19) United States
(12) Patent Application Publication
(10) Pub. No.: US 2010/0207338 A1
(43) Pub. Date: Aug. 19, 2010

(54) BOBSLEIGH

(76) Inventor: Peter Sulzenbacher, Kitzbuhel (AT)

Correspondence Address: KF ROSS PC, 5683 RIVERDALE AVENUE, SUITE 203 BOX 900, BRONX, NY, 10471-0900, US

(21) Appl. No.: 12/162,133

(22) PCT Filed: Jan. 29, 2007
(86) PCT No.: PCT/EP07/00732

§ 371 Date: Nov. 25, 2008

(30) Foreign Application Priority Data
Feb. 2, 2006 (AT) GM 79/2006

(51) Int. Cl. B62B 17/08

(52) U.S. Cl. 280/28.11

(57) ABSTRACT

The invention relates to a bobsled for traveling down a track that is covered with snow, ice, or a slide covering, and that has a bobsled body with a recessed seat, a support for the thighs, a grip projecting from the upper side of the bobsled, and a slide surface with runners on the underside, characterized in that the rear of the bobsled has a braking edge that extends over most of the width of the bobsled and that has a rounding on outer corners of the bobsled, and the runners extend longitudinally of the bobsled toward the braking edge, and the slide surface between the runners has a recess that widens toward the rear, or has a flat shape.

The invention relates to a bobsled for traveling down a track covered with snow, ice, or a slide covering, and which has a bobsled body with a recessed seat, a support for the thighs, a grip projecting from the upper side of the bobsled, and a slide surface with runners on the underside.

Such a bobsled is disclosed in DE 2 017 827 [GB 1,292,379], for example. This document describes a sled-like sport apparatus in which the bobsled body has a recessed seat, a support for the thighs, a grip projecting from the upper side of the bobsled, and a slide surface with runners on the underside. Such a bobsled, the same as for other similar commercially available bobsleds of this type, is suited for recreational riding on snow. However, these known bobsleds are not able to meet the requirements for a sport apparatus necessary for competition and semiprofessional racing. The known bobsleds in particular lack an aerodynamic design of the running surface, and the options for riding on open terrain as well as the possibilities for control are inadequate.

The object of the present invention, therefore, is to provide a bobsled for sporting use that avoids these disadvantages and also offers additional advantages, as described below.

The bobsled according to the invention is characterized in that the rear of the bobsled has a braking edge that extends over most of the width of the bobsled and that has a rounding on outer corners of the bobsled, and the runners extend longitudinally of the bobsled to the braking edge, and the slide surface between the runners forms a recess that widens toward the rear, or is flat.

Further advantageous features are contained in the claims and the following description, together with the drawings.

The invention is described in greater detail with reference to the drawings.

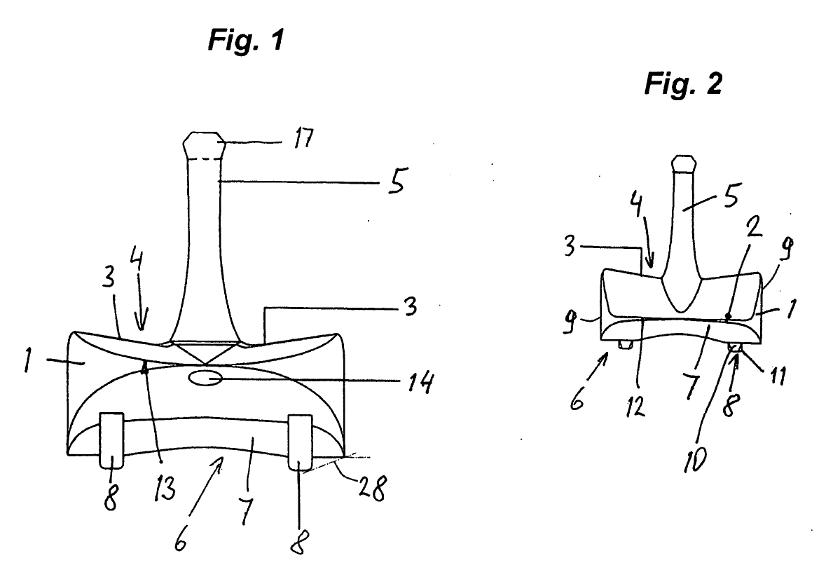

FIG. 1 is a front view,

FIG. 2 is a rear view, and

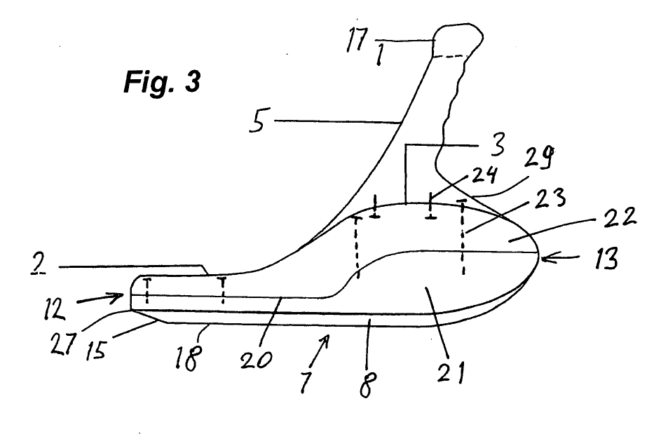

FIG. 3 is a side view of the bobsled.

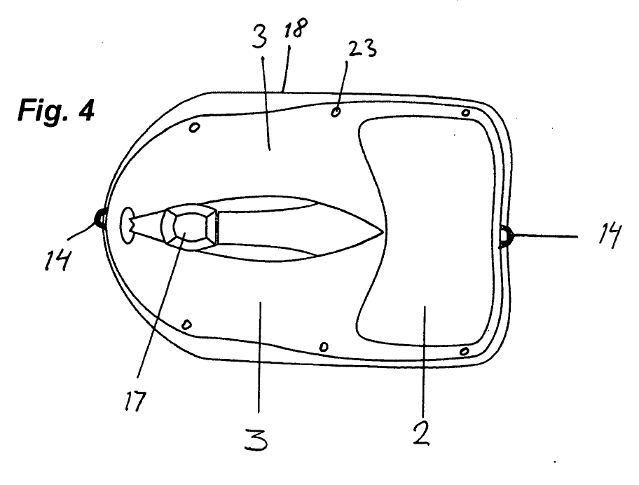

FIG. 4 is a top view, and

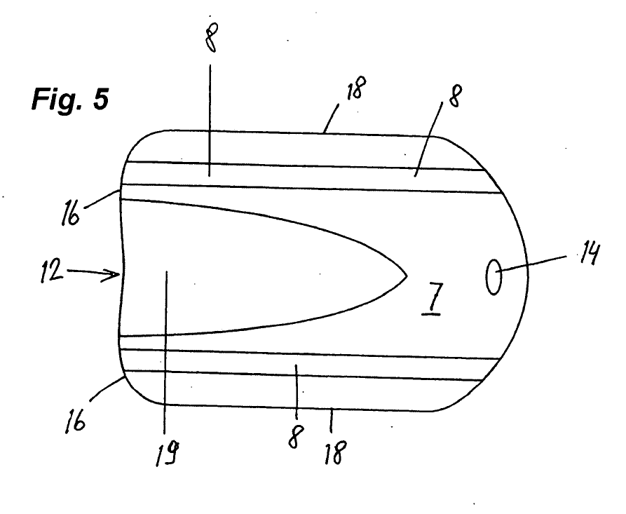

FIG. 5 is a bottom view of the running surface on the underside of the bobsled.

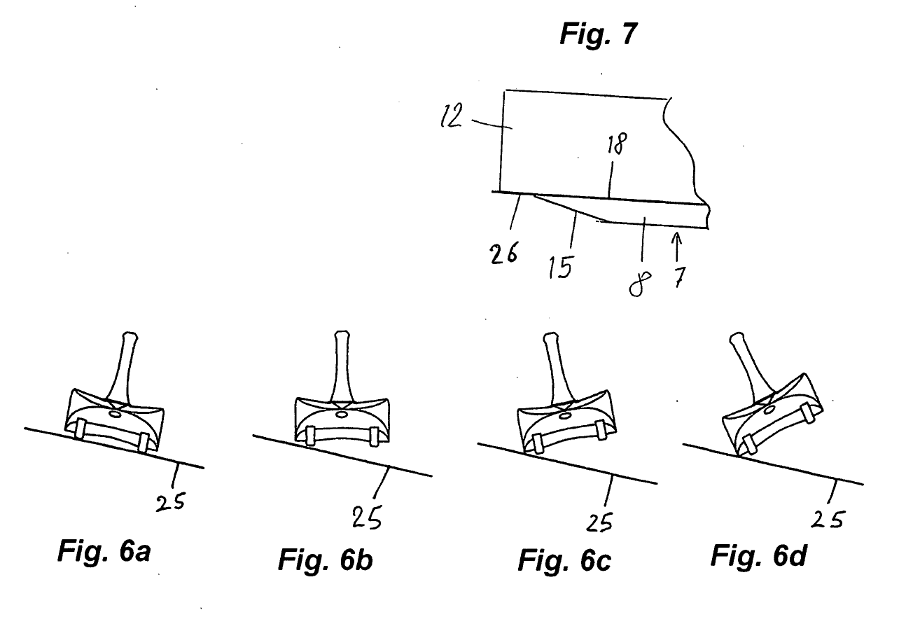

FIG. 6 is a front view of a bobsled according to the invention in four different functional positions on an inclined slope.

FIG. 7 is a side view of a variant on the bobsled, and

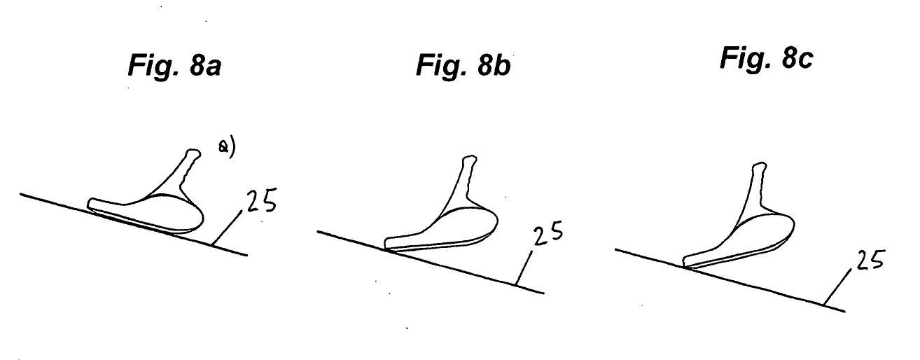

FIG. 8 is three different views of the bobsled traveling downhill on a slope during a braking maneuver.

FIG. 1 shows the front view and FIG. 2 shows the rear view of the bobsled. A bobsled body 1 has a seat 2 and a support 3 for the thighs of the bobsled rider. A grip 5 projects centrally from a top side 4 of the bobsled. A slide surface 7 together with runners 8 are located on an underside 6 of the bobsled. For better control of the bobsled the runners 8 are provided along longitudinal outer edges 9; FIG. 2 shows an embodiment in which the runners 8 are composed of runner attachments 11 joined to ribs 10 on the slide surface 7. FIGS. 1 and 2 show that the slide surface 7 has a continuous slightly concave shape. A recess is provided that extends to the rear 12. This recess widens toward the rear.

Viewed from the front end as shown in FIG. 1, and as shown in particular in the side view according to FIG. 3, the bobsled body 1 has an aerodynamically favorable teardrop shape, and on the top side the upper face of the bobsled body slopes from the support 3 down toward the nose 13. The runners 8 extend all the way to the nose region. At the tip of the nose 13 is provided a fastening means 14 (only indicated in the figure), for example a ring, eye, or simply a hole in the bobsled body 1, to which a carrying strap or pull cord may be attached. A similar fastening means may likewise be provided at the rear 12.

The grip 5 ends at the top with a knob 17 that may be removable, for example, so it can be customized.

FIG. 3 shows that the runners 8 are provided with a offset portion 15 toward the rear 12 with respect to the slide surface. The function of this offset rear end portion is explained below.

FIG. 4 is a top view of the bobsled body. In this case the fastening means 14 are eyes. According to the invention, the rear 12 has an essentially straight shape, thus forming a braking edge 27 by means of which the bobsled may be kept stable during braking. Toward the side of the bobsled the braking edge 27 has roundings 16. FIG. 5 shows that the runners 8 extend into the region of these roundings 16. As a result of this shape of the rear, it is possible to steer the bobsled in a curve, also during braking using the braking edge, or to brake during cornering.

The circumferential edge 18 of the slide surface 7, like with a ski or snowboard, is a means for guiding the bobsled, in particular during travel on an inclined slope or during cornering, and may preferably be hardened and in particular may also have a steel edge. FIG. 5 shows a recess 19 in the slide surface 7 that extends from the front third of the bobsled to the rear 12. The side view in FIG. 3 shows that the edge 18 of the bobsled has the shape of the edge of a ski, i.e., straight along the longitudinal outer edges and drawn upward toward the nose 13. A slight upward curve, as well as tapering of both edges in the top view, may be advantageous. The tapering may produce a carving ski effect.

The illustrations, for example FIGS. 2 and 3, clearly show that the shape of the bobsled is very streamlined while still allowing a comfortable sitting and supporting position for the buttocks and thighs. This facilitates control possibilities and provides for greater comfort during long rides.

The runners 8 or their attachments 11 may have replaceable sharper or softer edges in order to adapt the bobsled to snow conditions. The runner height and the distance to the edge according to FIG. 1 are preferably dimensioned in such a way that a connecting line 28 of the edges defines an angle α of approximately 25° to 35° with respect to the plane of the slide surface 7. As a result, during cornering at a corresponding inclined position of the bobsled the runner as well as the edge 18 cut into the slope, and for an even steeper inclination, only the edge 18 cuts into the slope (see FIG. 6c) and 6d)).

As shown in FIGS. 1 and 2, the supports for the thighs have a shape that merges continuously from the recessed seat 2 to the arched region, and the supports 3 are recessed toward the centrally located grip 5. This depression assists in supporting the thighs, and thus facilitates the controllability of the bobsled. The grip is curved from the seat 2 in order to avoid injuries. For improved guiding of the bobsled, a pressure surface 29 is provided that extends from the grip in the direction of the nose. This pressure surface improves the transmission of pressure from the thighs to the bobsled.

The bobsled body is preferably composed of one or more plastic shells that are glued or screwed together. These plastic shells may optionally filled with or formed by a foam. To allow the bobsled to be adapted to various conditions, the bobsled may also be provided in multiple parts that may be screwed together. This embodiment is shown in FIG. 3, in which a parting line 20 circumscribes the entire bobsled and divides the bobsled body into a lower or base part 21 and the upper part 22. This allows the appropriate slide surface 7 to be provided with suitable runners 8, depending on the track conditions. Screws 23 shown as dotted lines are provided for fastening the upper part 22 to the base part 21.

Similarly, the grip 5 may be removable to allow it to be individually adjusted. Screws for fastening it are shown by references 24. In FIG. 4 the screw heads of the screws 23 are visible, the position of which must naturally be adapted to the force distributions.

With regard to the edge 18 of the slide surface 7, it is noted that the edge along the longitudinal outer edges preferably are harder and in particular may be made of steel. It is also advantageous for the edge along the rear 12 to be hardened or provided with a steel edge. However, the hardened edge or steel edge may also be provided along the entire border of the slide surface 7, so that the hardened edge runs circumferentially.

FIG. 7 illustrates an embodiment of the rear 12 together with the runners 8. The inclined offset rear end portion 15 of the runners 8 ends at the slide surface 7 in a braking surface strip 26 that allows the braking capability of the bobsled to be improved when the bobsled body is engaged with the snow surface. FIG. 7 also shows the hardened steel edge 18 that may be laminated into the material of the bobsled body or of the base part 21 or the slide surface 7 and that may project beyond the rear 12 and its projections 16 in order to improve the gripping of the edge.

FIG. 6 shows the bobsled according to the invention in front view in various inclined positions. Illustration 6a) shows inclined travel on the slope 25, with equal load on both runners. In illustration b) the upslope runner is lodged more deeply, and the downslope runner is lifted up from the surface until, according to c), for negotiating a sharp curve the edge 18 of the slide surface 17 comes into contact with the snow surface, as shown in a more pronounced state in d). A tight uphill curve may be negotiated in this manner.

FIG. 8 shows the braking of the bobsled in three positions: in a) the bobsled is traveling downhill, unbraked, on its entire slide surface. In b) braking is initiated or is performed in a less intense manner, the offset rear end portion 15 of the runners 8 allowing the edge of the slide surface 7 to develop a braking effect at the rear. For more intense engagement according to c) the braking effect is much stronger. Of course, it is understood that in the shape of the rear according to FIG. 7, the configuration of the braking surface strip 26 allows the braking effect to be done for a less intense engagement of the bobsled, and also in a much more aggressive manner.

1-19. (canceled)

20. A bobsled for sliding down a track, the bobsled comprising:
a body having a front end, a rear end, a pair of longitudinal sides, an upper surface, and a lower surface, the upper surface being formed with a recessed seat and supports for the thighs of a person sitting in the seat;
a grip projecting upward from the upper surface between the supports;
a pair of longitudinally extending runners on the lower surface, the lower surface being flat or formed with a rearwardly flaring recess between the runners, the rear end being provided with a braking edge extending generally a full width of the rear end and having roundings at outer corners; and
an edge member extending along each of the longitudinal sides and having a longitudinally extending straight portion and a front end that curves upward at the front end.

21. The bobsled defined in claim 20 wherein the runners terminate adjacent the respective roundings.

22. The bobsled defined in claim 21 wherein each runner has a rear end portion that is offset from the rest of the runner.

23. The bobsled defined in claim 22 wherein the rear end portions are straight.

24. The bobsled defined in claim 20 wherein each member is hard.

25. The bobsled defined in claim 24 wherein each edge member is of steel.

26. The bobsled defined in claim 24, further comprising:
another hard edge member at the rear side joined to the edge members extending along the longitudinal sides.

27. The bobsled defined in claim 26, further comprising
another hard edge member at the front side joined to the edge members extending along the longitudinal sides, whereby the edge member extends annularly around the body.

28. The bobsled defined in claim 20 wherein the runners terminate short of the rear end of the bobsled and the lower surface forms between rear ends of the runners and the rear end of the body a braking surface strip.

29. The bobsled defined in claim 29 wherein the supports merge continuously with the seat and are below the grip.

30. The bobsled defined in claim 20 wherein lower surface is formed with the recess and is flat forward of the recess.

31. The bobsled defined in claim 20 wherein each runner is formed by a rib integral with the body and a hard sharp-edge runner attachment secured to the ridge.

32. The bobsled defined in claim 20 wherein the body is formed by an upper part and a lower part that are secured together.

33. The bobsled defined in claim 32 wherein the parts are foam-filled.

34. The bobsled defined in claim 20, further comprising a fastener at the front or rear end for connection to a carrying strap or pull cord.

35. The bobsled defined in claim 20 wherein the grip is detachable from the body.

36. The bobsled defined in claim 35 wherein the grip includes a removable knob.

37. The bobsled defined in claim 20 wherein the grip has a curved offset rear end portion joined to the seat.

38. The bobsled defined in claim 20 wherein the body is formed with a pressure surface between the grip and the front end.

39. The bobsled defined in claim 20 wherein a plane tangenting each runner and the respective longitudinal side extends at an angle of between 25° and 35° to a plane of the lower surface.
